(19) United States
(12) Patent Application Publication
(10) Pub. No.: US 2007/0168471 A1
(43) Pub. Date: Jul. 19, 2007

(54) Method for providing network resources

(76) Inventors: Rhonda L. Childress, Austin, TX (US); David B. Kumhyr, Austin, TX (US); Michael J. Spisak, East Northport, NY (US)

Correspondence Address: Frank C. Nicholas;CARDINAL LAW GROUP, Suite 2000, 1603 Orrington Avenue, Evanston, IL, 60201, US

(21) Appl. No.: 11/333,516

(22) Filed: Jan. 17, 2006

(51) Int. Cl. G06F 15/177

(52) U.S. Cl. 709/220

(57) ABSTRACT

A method of providing network resources for performing a target task includes determining a set of network accessible devices located at a location where the target task is to be accomplished and determining required user interface input/output hardware capabilities needed to accomplish the target task. The method further includes determining a target system configuration needed to accomplish the target task, selecting at least one of the network accessible devices based on the required user interface input/output hardware capabilities and the determined target system configuration, and providing configuration instructions to the selected device based on the device determination.

### FIELD OF INVENTION

The present invention generally relates to providing network resources. More specifically, the invention relates to aggregating network devices.

### BACKGROUND OF THE INVENTION

Operators of networks often must make undesirable tradeoffs between accommodating peak usage of the network, while conserving financial resources. However, networks cannot effectively operate beyond their capacity to operate. In situations where peak usage is limited to rare times, providing system resources to handle such usage can leave resources which are only utilized at peak times underutilized—a costly solution to network capacity. Additionally, limitations on hardware input/output functionality can further undesirably limit throughput of specific tasks. Further undesirable is a potential loss of revenue occasioned by a lack of sufficient network resources.

For example, a retailer may see peak demand for cash registers during the holiday season. Operating enough cash registers to meet peak holiday demand year round undesirably increases costs as the unneeded registers sit unused for more than 9 months of the year.

Location, and utilization of additional network resources is desirable. It is therefore a challenge to develop a method to provide network resources to overcome these, and other, disadvantages.

### SUMMARY OF THE INVENTION

A method of providing network resources for performing a target task includes determining a set of network accessible devices located at a location where the target task is to be accomplished and determining required user interface input/output hardware capabilities needed to accomplish the target task. The method further includes determining a target system configuration needed to accomplish the target task, selecting at least one of the network accessible devices based on the required user interface input/output hardware capabilities and the determined target system configuration, and providing configuration instructions to the selected device based on the device determination.

A method of device aggregation includes determining network accessible devices at a location where a target task is to be performed and user interface input/output capabilities of the network accessible devices. The method further includes determining a target system configuration required to perform the task, determining required user interface input/output capabilities to perform the target task based on the target system configuration, and requesting configuration approval from the determined devices based on the target system configuration and required user interface input/output capabilities. The method further includes providing configuration instructions to the devices based on configuration approval and aggregating the devices to perform the target task using the user interface input/output capabilities of the network accessible devices.

A computer usable medium including computer readable code for device aggregation includes computer readable code for determining network accessible devices at a location where a target task is to be performed and user interface input/output capabilities of the network accessible devices. The medium further includes computer readable code for determining a target system configuration required to perform the task, computer readable code for determining required user interface input/output capabilities to perform the target task based on the target system configuration, and computer readable code for requesting configuration approval from the determined devices based on the target system configuration and required user interface input/output capabilities. The medium further includes computer readable code for providing configuration instructions to the devices based on configuration approval and computer readable code for aggregating the devices to perform the target task using the user interface input/output capabilities of the network accessible devices.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a computer client, in accordance with one aspect of the invention;

FIG. 2 illustrates one embodiment of a network system for use in accordance with one aspect of the invention;

FIG. 3 illustrates an embodiment of a method for providing network resources, in accordance with one aspect of the invention;

FIG. 4 illustrates an embodiment of a method for providing configuration instructions, in accordance with one aspect of the invention;

FIG. 5 illustrates an embodiment of a method for determining network accessible devices, in accordance with one aspect of the invention;

FIG. 6 illustrates another embodiment of a method for determining network accessible devices, in accordance with one aspect of the invention;

FIG. 7 illustrates an embodiment of a method for providing network resources, in accordance with one aspect of the invention;

FIG. 8 illustrates an embodiment of a method for providing network resources in accordance with another aspect of the invention;

FIG. 9 illustrates another embodiment of a method for providing network resources, in accordance with one aspect of the invention; and

FIG. 10 illustrates another embodiment of a method for device aggregation, in accordance with one aspect of the invention.

### DETAILED DESCRIPTION OF THE PRESENT INVENTION

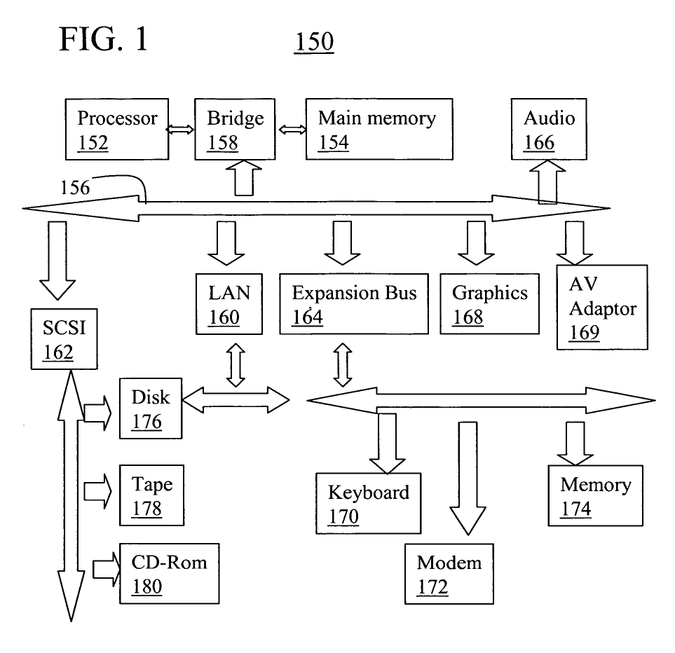

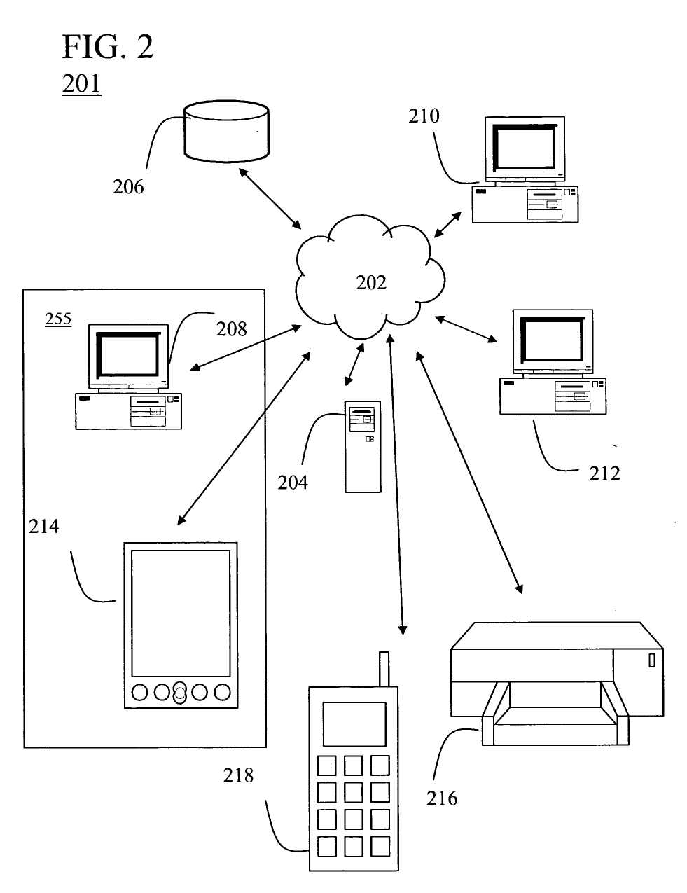

FIG. 1 illustrates one embodiment of a computer client 150 for use in accordance with one aspect of the invention. Computer system 150 is an example of a client computer, such as clients 208, 210, and 212 (FIG. 2). Computer system 150 employs a peripheral component interconnect (PCI) local bus architecture. Although the depicted example employs a PCI bus, other bus architectures such as Micro Channel and ISA may be used. PCI bridge 158 connects processor 152 and main memory 154 to PCI local bus 156. PCI bridge 158 also may include an integrated memory controller and cache memory for processor 152. Additional connections to PCI local bus 156 may be made through direct component interconnection or through add-in boards. In the depicted example, local area network (LAN) adapter 160, SCSI host bus adapter 162, and expansion bus interface 164 are connected to PCI local bus 156 by direct component connection. In contrast, audio adapter 166, graphics adapter 168, and audio/video adapter (A/V) 169 are connected to PCI local bus 156 by add-in boards inserted into expansion slots. Expansion bus interface 164 connects a keyboard and mouse adapter 170, modem 172, and additional memory 174 to bus 156. SCSI host bus adapter 162 provides a connection for hard disk drive 176, tape drive 178, and CD-ROM 180 in the depicted example. In one embodiment, the PCI local bus implementation support three or four PCI expansion slots or add-in connectors, although any number of PCI expansion slots or add-in connectors can be used to practice the invention.

An operating system runs on processor 152 to coordinate and provide control of various components within computer system 150. The operating system may be any appropriate available operating system such as Windows, Macintosh, UNIX, LINUX, or OS/2, which is available from International Business Machines Corporation. “OS/2” is a trademark of International Business Machines Corporation. Instructions for the operating system, an object-oriented operating system, and applications or programs are located on storage devices, such as hard disk drive 176 and may be loaded into main memory 154 for execution by processor 152.

Those of ordinary skill in the art will appreciate that the hardware in FIG. 1 may vary depending on the implementation. For example, other peripheral devices, such as optical disk drives and the like may be used in addition to or in place of the hardware depicted in FIG. 1. FIG. 1 does not illustrate any architectural limitations with respect to the present invention, and rather merely discloses an exemplary system that could be used to practice the invention. For example, the processes of the present invention may be applied to multiprocessor data processing system.

FIG. 2 illustrates an exemplary network system 201. Network system 201 is illustrative only, and is not an architectural limitation for the practice of this invention. Network system 201 is a network of computers in which the present invention may be implemented. Network system 201 includes network 202, which is the medium used to provide communications links between various devices and computers connected together within distributed network system 201. Network 202 may include permanent connections, such as wire or fiber optic cables, or temporary connections made through telephone connections. In other embodiments, network 202 includes wireless connections using any appropriate wireless communications protocol including short range wireless protocols such as a protocol pursuant to FCC Part 15, including 802.11, Bluetooth or the like, or a long range wireless protocol such as a satellite or cellular protocol.

In FIG. 2, a server 204 is connected to network 202 along with storage unit 206. In addition, clients 208, 210, and 212 also are connected to a network 202. These clients 208, 210, and 212 may be, for example, personal computers or network computers. For purposes of this application, a network computer is any computer, coupled to a network, which receives a program or other application from another computer coupled to the network. In the depicted example, server 204 provides data, such as boot files, operating system images, and applications to clients 208-212. Clients 208, 210, and 212 are clients to server 204. Network system 201 may include additional servers, clients, and other devices not shown. In the depicted example, network system 201 is the Internet with network 202 representing a worldwide collection of networks and gateways that use the TCP/IP suite of protocols to communicate with one another. Network system 201 also may be implemented as a number of different types of networks, such as for example, an intranet or a local area network.

In addition to network clients 208-212, network system 201 includes network accessible devices 214, 216, and 218. Each of network accessible devices 214, 216, and 218 is configured to communicate with other network accessible devices or clients 208-218 using a wireless or wired network. For example, network accessible device 214 is implemented as a personal digital assistant (PDA), while network accessible device 216 is implemented as a printer, as shown in FIG. 2. Additionally, network accessible device 218 is implemented as a cellular telephone as shown in FIG. 2. Other network accessible devices are within the scope of this disclosure, and network accessible devices 214-218 are described as PDAs, printers, and cellular telephones only for exemplary purposes. For example, other network accessible devices can include video game systems, magnetic stripe readers, displays, bar code scanners, infrared scanners, scanning devices, audio/visual devices such as MP3 players or DVD players, and the like.

FIG. 2 additionally illustrates a location 255. Location 255 describes a geographic location where a target task is to be performed. As illustrated in FIG. 2, client 208 and device 214 are located at location 255. A target task is any action that involves use of input/output capability of at least one device 214-218. For example, one exemplary target task is scanning a bar code. Another exemplary target task is printing a receipt. Another exemplary target task is displaying a price on a monitor. Although execution of a target task can require use of CPU resources, the target task itself requires use of input/output capability to send or receive information into a CPU, and the target task itself does not relate solely to execution of calculations using a CPU. In one example, location 255 is a retail store.

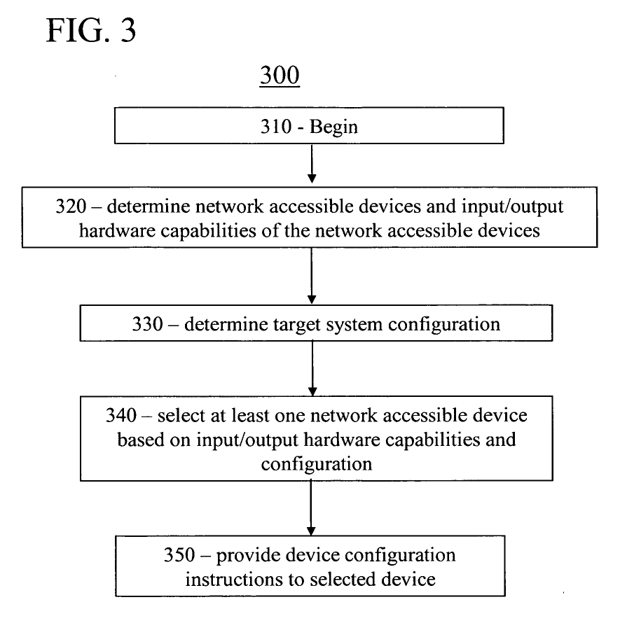

FIG. 3 illustrates one embodiment of a method 300 for providing network resources, in accordance with one embodiment of the invention. Method 300 begins at 310. Method 300 then determines network accessible devices located at a location where the target task is to be accomplished and the required user interface input/output hardware capabilities needed to accomplish the target task at step 320. Determining network accessible devices, as in step 320, can comprise any known method to locate devices on a network, or configured to communicate with the network. For example, a server can ‘ping’ the network to determine devices that receive the ‘ping.’ Each of the devices must be at the location where the target task is to be accomplished, or at least, capable of readily being moved to the location. After determining the network accessible devices on the network, the server can individually poll each network accessible device to determine its capabilities, including user interface input/output hardware capabilities. The capability of a network accessible device includes its hardware configurations, as well as software configuration. User interface input/output hardware capabilities are defined as any hardware used to send information to or from a CPU of a processor with an interface. For example, user interface input/output hardware capabilities include, without limitation, displays, keypads, infrared (IR) scanning devices, printers, and the like. For example, a network can access a particular PDA, and after the network determines the PDA is a network accessible device, the PDA is polled to determine that the PDA features a CPU, 16 MB of memory, a Bluetooth connection, and an IR scanner. Therefore, the particular PDA has the capability to communicate wirelessly within a limited area, a CPU that can process calculations, memory to store data, and the ability to exchange or read information using the IR scanner. In another example, a network printer is determined as a network accessible device, with the capabilities of color printing 5 pages per minute. Network accessible device capability includes software that manages hardware functionality.

A target system configuration is determined at step 330. A target system configuration identifies a user interface input/output hardware capability that is not currently satisfied by the existing network resources. A network may lack user interface input/output hardware resources based on network utilization or based on a lack of user interface input/output hardware or software. For example, a network can only operate at 100% of capacity, and if additional requirements are placed on the network, the network cannot provide the desired throughput. In another example, a network may require user interface input/output hardware capacity that is not currently available to the network. For example, a particular network may lack infrared scanning capacity at a time that infrared scanning capacity is required or would be beneficial to network operations.

At least one network accessible device is selected based on the required user interface input/output hardware capabilities and target system configuration at step 340. For example, if a target system needs additional printing capacity, a network accessible device featuring a printing capability is selected to provide additional printer throughput. Alternatively, a network accessible device featuring an IR scanner is selected based on a need for IR scanning capabilities.

Based on the network accessible device determination, device configuration instructions are provided to the network accessible device at step 350. Depending on input/output hardware device capability, the ability to operate the input/output hardware configuration is either within the software capacity or not within the software capacity of the determined network accessible device. In the event that the current software does not offer the desired functionality for the user interface input/output hardware, device configuration instructions are provided to the network accessible device. Device configuration instructions are instructions that provide the desired functionality to the determined network accessible device to operate the user interface input/output hardware in the desired fashion. In one embodiment, the instructions repurpose the input/output hardware to perform functions other than their design purpose. For example, device configuration instructions, in one embodiment, allow a PDA to use the IR communication device capability as a bar code scanner, rather than the design purpose of information exchange between devices.

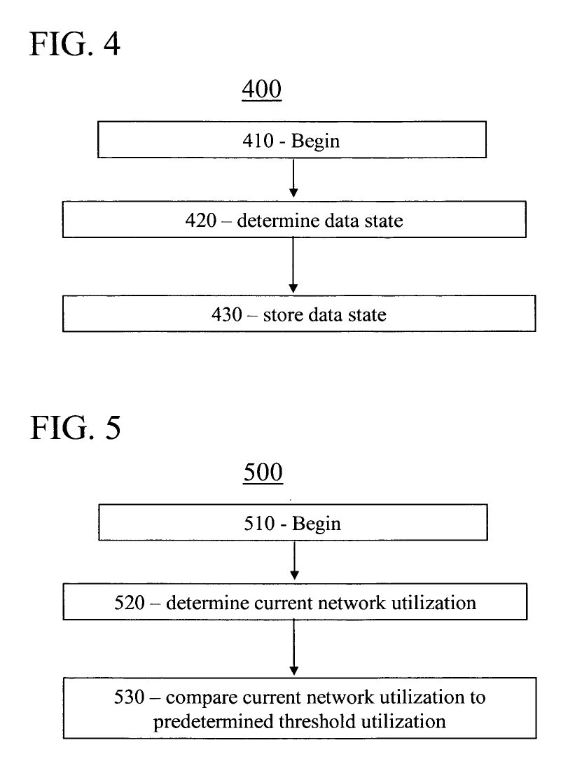

FIG. 4 illustrates one embodiment of a method 400 for providing device configuration instructions in accordance with the invention. In one embodiment, method 400 is implemented during step 350 of method 300. Method 400 begins at 410.

A data state of the determined network accessible device is determined at step 420. A data state refers to the state of the device, including all configuration arrangements, memory, files, and the like. The data state is stored at a server in communication with the determined network accessible device at step 430. Use of method 400 provides the network with the ability to ‘image’ the device prior to providing the device configuration instructions, and to restore the device to its original data state when the network accessible device is not required for network operations. Imaging a device is defined as copying the contents of memory and storage from a network accessible device to a separate location.

FIG. 5 illustrates one embodiment of a method 500 for determining target system need, in accordance with one aspect of the invention. Method 500 begins at 510. Current network utilization is determined at step 520. For example, a current network is utilized at 90% of capacity. In one embodiment, network utilization is established based on visual factors, such as an observation that customers have congregated in queues surrounding available network resources such as cash registers. In such embodiments, the determination of network capacity is based on receiving a network capacity command. A network capacity command is a command that instructs a network to begin the methods disclosed herein. In the event that a network capacity command is received, method 500 will not proceed to step 530.

The current network utilization is compared to a predetermined threshold utilization at step 530. The predetermined threshold utilization is a level of network utilization that is within network capacity but, in one embodiment, is approaching capacity. For example, a predetermined threshold utilization is set at 90% of capacity. In one embodiment, method 300 only provides device configuration instructions to a determined device if the current network utilization exceeds the predetermined threshold utilization, based on the method 500 determinations.

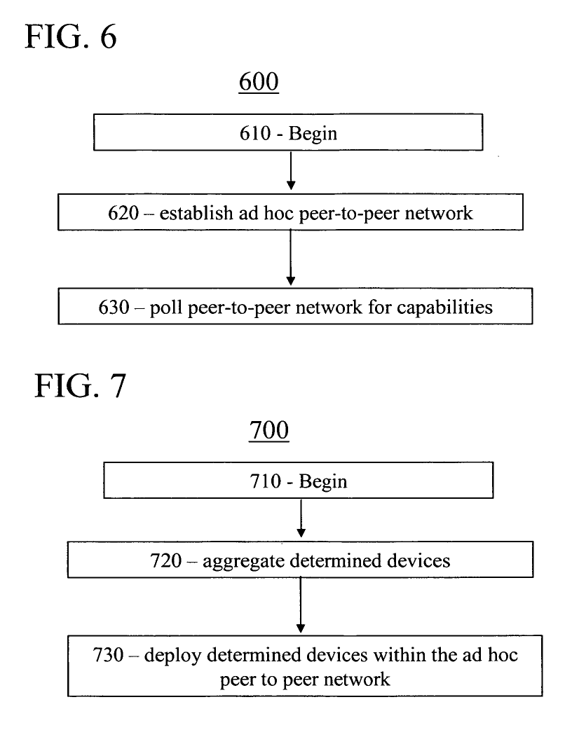

FIG. 6 illustrates one embodiment of a method 600 for determining network accessible devices, in accordance with one aspect of the invention. Method 600, in one embodiment, is implemented during step 320 of method 300. Method 600 begins at 610. An ad hoc peer-to-peer network is established at step 620. An ad hoc peer-to-peer network is formed to determine devices accessible to the network. Based on the formed ad hoc peer-to-peer network, each device on the ad hoc network is polled to determine user interface input/output hardware capabilities of the polled devices at step 630. Polling network devices can be implemented with any appropriate polling strategy.

FIG. 7 illustrates one embodiment of a method 700 for providing network resources, in accordance with one aspect of the invention. Based on the established ad hoc peer-to-peer network of step 620, the determined devices are aggregated to the established ad hoc peer-to-peer network at step 720. After aggregating the devices into the ad hoc peer-to-peer network, the determined devices are deployed within the ad hoc peer-to-peer network at step 730. Deploying the determined devices includes operating the determined devices to utilize their user interface input/output hardware capabilities using the device configuration instructions. Deploying the determined devices further includes operating the selected devices to accomplish the target task.

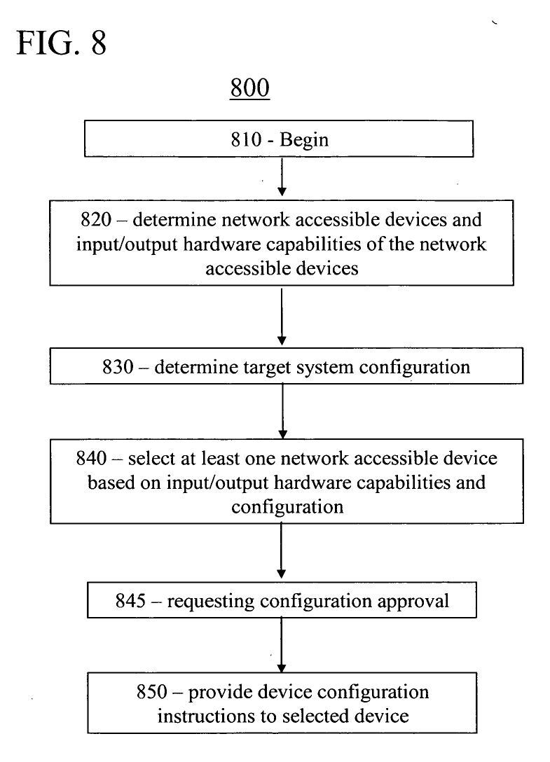

FIG. 8 illustrates another embodiment of a method 800 for providing network resources in accordance with one aspect of the invention. Method 800 begins at 810. Network accessible devices are determined and the user interface input/output hardware capabilities of the determined network accessible devices are determined at step 820. In one embodiment, step 820 is implemented as in step 320. At step 830, method 800 determines a target system configuration. In one embodiment, step 830 is implemented as in step 330. At least one network accessible device is selected based on the user interface input/output hardware capabilities and target system need at step 840. In one embodiment, step 840 is implemented as in step 340.

Configuration approval is requested from the selected network accessible device at step 845. Requesting configuration approval includes issuing a prompt requesting access to configure the device and receiving a response from the device. The prompt can be sent to the device, or to an access server. For example, if the determined device is a PDA, a prompt can be sent to be displayed on the PDA display requesting access to provide the configuration instructions. Alternatively, if the selected device is a network printer, a request can be sent to a network authorization server to grant access to the network printer. Alternatively, a unique identifier (such as a serial number) can be determined for each selected device and this unique identifier compared to a predetermined database to determine whether the network has permission to provide device configuration instructions to the device. In one embodiment, requesting configuration approval reduces the incidence of providing device configuration instructions to devices that are not owned or controlled by the same entity that owns the network. For example, a retail store would not desire to provide device configuration instructions to a customer's PDA because the customer could become dissatisfied with the retailer, and the newly configured device can leave the network access area, resulting in potentially unnecessary iterations of the methods disclosed herein. Other permission-based schemes can be utilized to secure permission to send configuration instructions to the selected devices.

Based on receiving configuration approval, step 850 provides device configuration instructions to the selected device. In one embodiment, step 850 is implemented as in step 350.

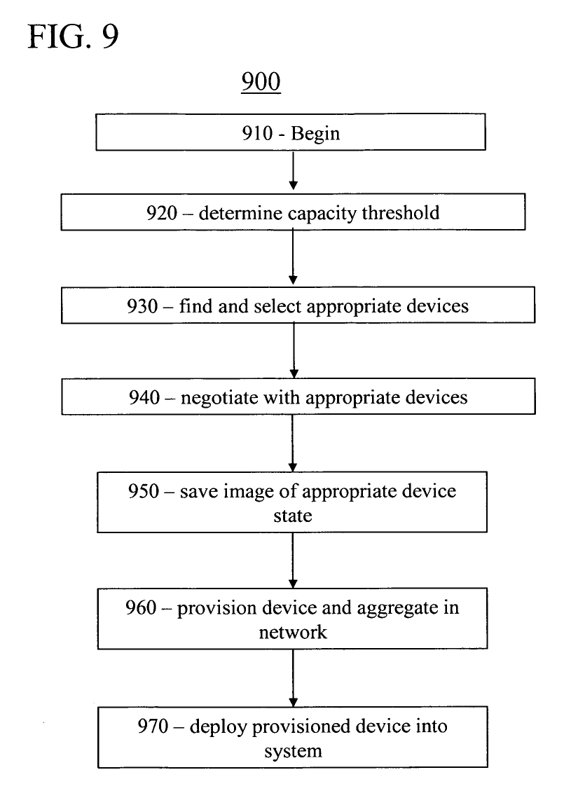

FIG. 9 illustrates another embodiment of a method 900 for providing network resources in accordance with one aspect of the invention. Method 900 begins at 910. At step 920, method 900 determines whether the standard or pre-existing system is approaching the capacity of the system. If capacity is approaching, method 900 finds and selects appropriate devices to increase the capacity of the system at step 930. Finding and selecting appropriate devices includes identifying a system need as well as locating devices capable of fulfilling the identified system needs. Devices can be located by polling a network, such as a wired or wireless network, to identify devices as well as the identified devices hardware and software configurations.

Based on the found appropriate devices, method 900 negotiates with the found appropriate devices at step 940. Negotiating with the found appropriate devices includes determining if method 900 has permission to repurpose or take over operation of the found appropriate devices. In one embodiment, step 940 is implemented in similar fashion as step 845.

Based on securing permission to take over the device, in one embodiment, an image of the current device state is saved, during step 950, using a memory location separate from, but in direct or indirect communication with, the device. The image can be saved in an exact image, or a compressed form, or cryptographically protected.

The device is provisioned with instructions to operate in the desired fashion at step 960, and aggregated with the network. Providing the device with instructions includes determining what instructions are necessary to repurpose the device to function as required and providing those necessary instructions to the device. Instructions can be located from an instruction server in communication with the network, or customized based on network needs. Aggregating the device includes adding the device to the network.

At step 970, the provisioned device is deployed into the network to increase network resources.

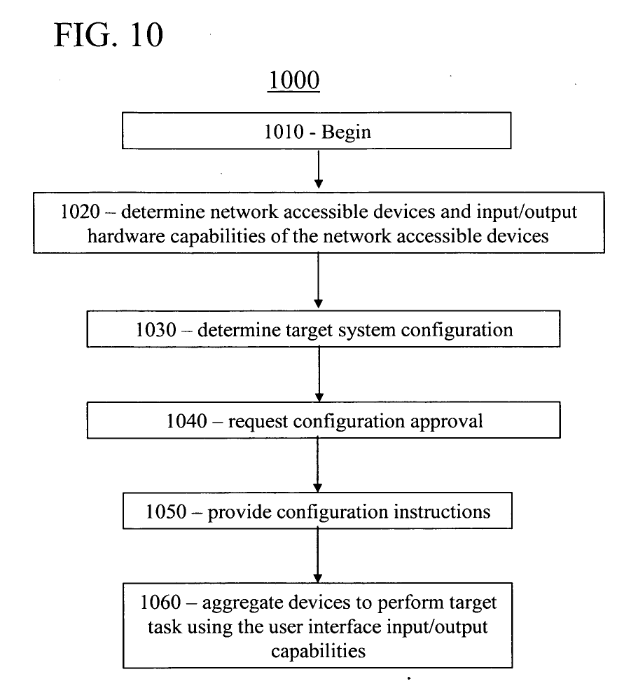

FIG. 10 illustrates another embodiment of a method 1000 for device aggregation in accordance with one aspect of the invention. Method 1000 begins at 1010. At step 1020, method 1000 determines network accessible devices and capabilities of the network accessible devices. In one embodiment, step 1020 is implemented as in step 320. Method 1000 determines a target system configuration at step 1030. In one embodiment, step 1030 is implemented as in step 330.

Based on the identified network accessible devices and target system needs, method 1000 requests configuration approval from the selected devices at step 1040. In one embodiment, step 1040 is implemented as step 845.

Based on receiving approval from the selected devices, method 1000 provides configuration instructions to the selected device(s) at step 1050. In one embodiment, step 1050 is implemented as in method 600. The devices are then aggregated within the peer-to-peer network at step 1060. In one embodiment, step 1060 is implemented as in method 700.

In one embodiment, the aggregated determined devices are compared to a predetermined system configuration. For example, the aggregated determined devices either do or do not include each capability of the predetermined system configuration. Depending on system needs, although the aggregated determined devices do not include each capability, the aggregated determined devices are accepted or rejected. The determination of whether to accept or reject the aggregated determined devices is a function of, for example, system needs, criticality of the predetermined system configuration as compared to the aggregated determined devices, or other factors. Thus, the aggregated determined devices can be accepted whether the configuration is optimal or sub-optimal, responsive to user needs, for example.

For example, a retail store operates a system with 5 cash registers at a time when customer demands require 6 cash registers. A cash register, broken into components, includes a receipt printer, magnetic stripe reader, bar code reader, display, keypad and cash drawer. In order to service the customers, the network desires to recreate the functionality of a cash register to provide a sixth cash register. The network determines that available network devices include a PDA, network printer and a drawer. The PDA features a display, keypad, and an IR scanner. A server in communication with the network includes instructions to program a PDA to operate the IR scanner as a bar code reader. The network negotiates with the PDA to determine if the network can take over PDA operation, and negotiates to determine if the network can operate the network printer. Based on approval to take over the PDA and operate the network printer, an image is taken of the data state of the PDA and the image is stored. The PDA is overwritten with instructions to use the IR scanner as a bar code reader and the display and keypad in accordance with a cash register function. The reprogrammed PDA is then deployed to function as a cash register display, keypad and bar code reader. In this example, no magnetic stripe reader was located, so that the register would need to function as cash-only—had a magnetic stripe reader been found, the magnetic stripe reader could be used to function as a credit card reader.

In another embodiment, a network determines a user interface input/output hardware configuration based on network utilization and determines at least one device not currently operating within the network that provides at least one element of the user interface input/output hardware configuration. The devices are located at a location, such as location 255, where a target task is to be accomplished using the input/output hardware configuration. The at least one devices providing at least one element of the user interface input/output hardware configuration are aggregated together, and the aggregated devices are configured with the determined user interface input/output hardware configuration, and added to the network. Configuring the determined devices includes, in one example, seeking configuration approval from the device(s), and providing configuration instructions to the devices.

In yet another embodiment, determining network accessible devices includes receiving a request from a network accessible device to join the network. In one embodiment, an airline operates 5 ticket kiosks at a busy airport, and customer demand for ticketing services at a particular time exceeds the capacity of the 5 ticket kiosks to serve the airline's customers with the quality of service desired by the airline and/or customer. In such an embodiment, the airline, for example, posts a network address for a customer to direct an access request to a particular location. For example, a sign indicates that a PDA can access a particular network address to perform ticketing operations (e.g. purchasing tickets, confirming tickets, printing tickets). Based on the sign, the network receives a request from a network accessible device, determines the input/output hardware capabilities of the network accessible device, selects the device based on the device capabilities and provides device configuration instructions to the device.

In another embodiment, a wireless communications area is created so that customers can deliberately avail themselves of the benefits of network access. For example, an airport sets up a wireless communications zone, such as using short range wireless communications protocols such as Bluetooth or 802.11, and directs customers who wish to access a ticketing network using their own compatible devices to enter the wireless communications area. In one embodiment, the wireless communications area is defined by a transmission range of the wireless communications protocol. In another embodiment, the wireless communications area is defined by structures limiting the transmission range of the wireless communications protocol.

In another embodiment, a ticket kiosk network does not have the capacity to serve customers in a desired fashion, and attempts to aggregate devices to perform the necessary input/output tasks to improve customer service. To implement such an attempt, any of the methods 300, 400, 500, 600, 700, 800, 900, or 1000 can be implemented in similar fashion as described herein.

In yet another embodiment, devices are aggregated to serve as a point of sale terminal. For example, one point of sale terminal application includes a magnetic stripe reader, a scanner for determining an indicator of at least one product to be purchased, and communication devices (e.g. wireless or wired communication device) to communicate the results of operating the magnetic stripe reader to a central server (e.g. credit /debit card approval center) and receiving a response (e.g. approve/decline) from the central server.

In another embodiment, a shipping facility utilizes a network of shipping kiosks for entering address and payment data and printing shipping documents. The shipping kiosks can be publicly accessible, or located within a non-publicly accessible area. In the event that packages are not being processed at a desired rate, or customers desire to operate their own network accessible devices to enter the address and payment information, any of the methods 300, 400, 500, 600, 700, 800, 900, or 1000 can be implemented in similar fashion as described herein to increase network input/output hardware capacity. A shipping kiosk network can increase throughput of input/output hardware such as a printer by leveraging customer or other network accessible devices to receive address and/or payment data.

It should be noted that both the server and devices can reside behind a firewall, or on a protected node of a private network or LAN connected to a public network such as the Internet. Alternatively, the server and devices can be on opposite sides of a firewall, or connected with a public network such as the Internet. The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device), or a propagation medium such as a carrier wave. Examples of a computer-readable medium include a semiconductor or solid state memory, magnetic tape, a removable computer diskette, a random access memory (RAM), a read-only memory (ROM), a rigid magnetic disk and an optical disk.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of providing network resources for performing a target task, the method comprising:
determining a set of network accessible devices located at a location where the target task is to be accomplished;
determining required user interface input/output hardware capabilities needed to accomplish the target task;
determining a target system configuration needed to accomplish the target task;
selecting at least one of the network accessible devices based on the required user interface input/output hardware capabilities and the determined target system configuration; and
providing configuration instructions to the selected device based on the device determination.

2. The method of claim 1 wherein providing device configuration instructions comprises determining a data state of at least one determined device and storing the data state at a server.

3. The method of claim 1 wherein determining target system configuration comprises:
determining a current network utilization; and
comparing the current network utilization to a predetermined threshold utilization.

4. The method of claim 1 wherein determining network accessible devices comprises establishing an ad hoc peer-to-peer network, and wherein determining capabilities of the devices comprises polling the devices for device capabilities.

5. The method of claim 4 further comprising aggregating the determined devices into the ad hoc peer-to-peer network and deploying the determined devices within the ad hoc peer-to-peer network.

6. The method of claim 5 wherein deploying the determined devices comprises comparing the aggregated determined devices to a predetermined system configuration and accepting the aggregated determined devices.

7. The method of claim 1 further comprising:
requesting configuration approval from the determined devices.

8. The method of claim 1 wherein the target task includes at least one user interaction.

9. The method of claim 1 wherein the location is a retail store and the target system configuration is a cash register configuration.

10. A method of device aggregation, the method comprising:
determining network accessible devices at a location where a target task is to be performed and user interface input/output capabilities of the network accessible devices;
determining a target system configuration required to perform the task;
determining required user interface input/output capabilities to perform the target task based on the target system configuration;
requesting configuration approval from the determined devices based on the target system configuration and required user interface input/output capabilities; and
providing configuration instructions to the devices based on configuration approval; and
aggregating the devices to perform the target task using the user interface input/output capabilities of the network accessible devices.

11. The method of claim 10 wherein determining the target system configuration comprises:
determining a current network utilization; and
comparing the current network utilization to a predetermined threshold utilization.

12. The method of claim 10 wherein aggregating the devices comprises determining a data state of at least one determined device and storing the data state at a server.

13. The method of claim 10 further comprising comparing the aggregated determined devices to a predetermined system configuration and accepting the aggregated determined devices.

14. A computer readable medium including computer readable code for device aggregation, the medium comprising:
computer readable code for determining network accessible devices at a location where a target task is to be performed and user interface input/output capabilities of the network accessible devices;
computer readable code for determining a target system configuration required to perform the target task;
computer readable code for determining required user interface input/output capabilities to perform the target task based on the target system configuration;
computer readable code for requesting configuration approval from the determined devices based on the target system configuration and required user interface input/output capabilities; and
computer readable code for providing configuration instructions to the devices based on configuration approval; and
computer readable code for aggregating the devices to perform the target task using the user interface input/output capabilities of the network accessible devices.

15. The medium of claim 14 wherein computer readable code for determining target system configuration comprises:
means for determining a current network utilization; and
means for comparing the current network utilization to a predetermined threshold utilization.

16. The medium of claim 14 wherein the location is a retail store and the target system configuration is a cash register configuration and wherein the computer readable code for providing configuration instructions includes computer readable code for programming a personal digital assistant to use a infrared communications device as a scanner.

17. The medium of claim 14 wherein the configuration instructions include computer readable code to repurpose the input/output hardware.
